(19) United States
(12) Patent Application Publication
(10) Pub. No.: US 2026/0120207 A1
(43) Pub. Date: Apr. 30, 2026

(54) COMPREHENSIVE EVALUATION METHOD FOR IMPLEMENTATION EFFECT OF ECOLOGICAL RIVER BOTTOM PROTECTION ENGINEERING (RBPE) OF INLAND CHANNEL

(71) Applicant: China Waterborne Transport Research Institute, Beijing (CN)

(72) Inventors: Jinpeng LI, Beijing (CN); Rongchang CHEN, Beijing (CN); Bing QIAO, Beijing (CN)

(73) Assignee: China Waterborne Transport Research Institute, Beijing (CN)

(21) Appl. No.: 19/274,683

(22) Filed: Jul. 21, 2025

(30) Foreign Application Priority Data
Oct. 30, 2024 (CN) 202411523710.2

(51) Int. Cl. G06Q 50/06; G06Q 10/0631; G06Q 30/018

(52) U.S. Cl. CPC G06Q 50/06; G06Q 10/06313; G06Q 30/018

(57) ABSTRACT

Provided is a comprehensive evaluation method for an implementation effect of ecological river bottom protection engineering (RBPE) of an inland channel. In view of the existing evaluation method for the implementation effect of the ecological RBPE of the inland channel and its shortages and defects in long-term tracking and monitoring on the ecological restoration effect, the comprehensive evaluation method for an implementation effect of ecological RBPE of an inland channel includes a comprehensive evaluation index system for the ecological RBPE of the inland channel, a weight and score criterion system of each index based on the comprehensive evaluation index system for the ecological RBPE of the inland channel, and an evaluation criterion system on the implementation effect of the ecological RBPE of the inland channel based on an ecological compliance index rating of river bottom protection engineering (ECIR-RBPE).

### CROSS REFERENCE TO THE RELATED APPLICATIONS

This application is based upon and claims priority to Chinese Patent Application No. 202411523710.2, filed on Oct. 30, 2024, the entire contents of which are incorporated herein by reference.

### TECHNICAL FIELD

The present disclosure provides a comprehensive evaluation method for an implementation effect of an ecological river bottom protection engineering (RBPE) of an inland channel, and belongs to the technical field of ecological environmental protection and evaluation in water transport engineering.

### BACKGROUND

### (1) Definition and Content of RBPE

As an important part of inland channel regulation engineering, conventional RBPE typically makes use of a granular river bottom protection structure such as riprap, a mattress-type river bottom protection structure, and a modular frame or component to prevent the riverbed or regulation engineering from scour, ensuring the structural stability and safety. However, these river bottom protection structures artificially obstruct the vertical connectivity and continuity of rivers, often leading to losses in biomass and biodiversity of macrobenthos. In recent years, construction of the ecological RBPE has become a development trend of channel regulation engineering at home and abroad, and an important approach for realizing biodiversity protection and water ecological restoration of rivers. It not only meets design requirements of the channel engineering, but also facilitates settlement and growth of macrobenthos, and provides suitable habitats and living environments for aquatic organisms, making the river ecosystem more stable.

Based on the research of scholars at home and abroad in recent years, the ecological RBPE of the inland channel is to artificially construct natural or man-made materials at a riverbed or a base of the regulation structure with certain spatial layouts and structural forms and make adaptations to deformations, retarding a water flow to promote deposition, preventing the riverbed from being scoured, and stabilizing the regulating structure. Meanwhile, it facilitates exchange between overlying water and sediment, fosters settlement and growth of the macrobenthos, aquatic plants and attaching organisms, and can provide certain habitats for aquatic nektons, thereby meeting the engineering design and navigation objective, and achieving integration of the structural stability, material eco-friendliness, engineering layout rationality, engineering economy, and river ecosystem service function. Therefore, comprehensive evaluation on an implementation effect of the ecological RBPE of the inland channel in the present disclosure includes the structural stability, the material eco-friendliness, the engineering layout rationality, the engineering economy, and the ecosystem service function.

### (2) Novel Structures and Current Evaluation System Research of the Ecological RBPE

In recent years, in the implementation of the inland channel regulation engineering of the Yangtze River and the like, a series of novel structures, such as concrete block soft mattresses, D type soft mattresses, sand-wave ballast-block soft mattresses, and permeable frames, have been successively adopted, realizing beneficial explorations in the construction of ecological RBPE of the inland channel. With tracking on related research, the comprehensive evaluation on the implementation effect of the ecological RBPE remains relatively scarce in China, and a corresponding evaluation index system has yet to be established. For example:
1) Gao Zhifeng conducted the Analysis of Advantages and Disadvantages of Various River Bottom Protection Solutions in Inland channel Regulation Engineering. In this article, with engineering cases, advantages and disadvantages of various solutions including mold-bagged concrete river bottom protection, concrete hinged mattress river bottom protection, cast-in-place concrete river bottom protection or grouted riprap river bottom protection were discussed in detail from applicability and limitation, providing suitable solutions for different projects in the inland channel regulation engineering. The advantages and disadvantages of various conventional river bottom protection solutions were only compared simply and qualitatively from the soil texture, navigation reach, bank type, environmental compliance, cost, and construction condition. The indexes are relatively few, and not applicable to the comprehensive evaluation on characteristics and ecological implementation effects of ecological RBPE of inland channels (China Water Transport, 2022, (1), pp 133-135).
2) Cao Minxiong, Shen Xia and Ying Hanhai conducted the Study on Ecological Structures of Waterway Regulation in the Yangtze River below Nanjing, developed such ecological river bottom protection structures as a stereoscopic mattress, an active hooked structure and a double-I-shaped permeable frame, and briefly analyzed action mechanisms of various ecological river bottom protection structures. Results reveal that the various ecological river bottom protection structures achieve remarkable economic and ecological benefits and have good promotion and application values. However, for implementation effects of the various ecological river bottom protection structures in phase I and phase II projects of the 12.5 m deep channel in the Yangtze River below Nanjing, there is neither quantitative comprehensive evaluation, nor establishment of a corresponding evaluation index system in the article (Port & Waterway Engineering, 2018, (1), pp 1-11).
3) Liu Qifeng, Zhu Yuanzhang, Huang Wei and Chen Yijun explored the design concept of bank protection in channel regulation at the middle and lower Yangtze River, and introduced structural forms and application situations of underwater ecological structures including a permeable frame and a fish nest brick. However, for implementation effects of the underwater ecological structures, there is neither comprehensive evaluation, nor establishment of a corresponding evaluation index system in the article (Express Water Resources & Hydropower Information, 2017, 38(11), pp 53-55+78).
4) With a view to innovations of novel structures in river bottom (beach) protection, high beach protection, damming and the like of channel regulation in Jinjiang reach, Chai Huafeng proposed such novel river bottom protection structures as a D-type interlocking mattress, an integrally formed permeable frame, and a novel flexible water-grass mattress. However, for implementation effects of the novel river bottom protection structures, there is neither comprehensive evaluation, nor establishment of a corresponding evaluation index system in the article (China Water Transport, 2016, (1), pp 43-50).
5) Niu Lanhua, Li Yunzhong and Du Linxia analyzed the fluvial processes at key points in the downstream river of the Three Gorges Project based on prototype observation data, carried out long-term tracing observation and analytical research on the RBPE at Yanzhiba, and concluded that the RBPE with the riprap-filled trench and the concrete block soft mattress was significant to achieve stability and scour resistance of the riverbed. In the article, the protection effect of the RBPE was analyzed from the deposition height, deposition amount, bed roughness, and the like. However, a corresponding evaluation index system is not established and comprehensive evaluation on the implementation effect is not conducted (Journal of Yangtze River Scientific Research Institute, 2014, 31(6), pp 123-129).
6) On the basis of investigation and analysis on environment-friendly structures in channel regulation at the middle and lower Yangtze River, Li Yibing and Cheng Xiaobing summarized characteristics and practicability of existing environment-friendly materials and processes available for channel regulation, proposed forms and materials of the environment-friendly regulating structures, and specified applicable sites of these materials and structures in surface protection, bottom protection, beach protection and bank protection. However, in the article, comprehensive evaluation on implementation effects of the river bottom protection structures is not conducted, and a corresponding evaluation index system is also not established (Journal of Waterway and Harbor, 2012, 33(5), pp 397-404).
7) Wu Peng, Jiang Junjie and Cao Fengshuai introduced categories and main functions of geosynthetic materials, summarized application situations of the geosynthetic materials in water transport engineering, elaborated research and engineering practices on the river bottom protection structures such as the soft mattress and active hooked structure, and indicated further application and development directions of the geosynthetic materials (Port & Waterway Engineering, 2017, (6), pp 16-22).
8) Peng Hao, Li Biao, Sun Baohu, Ouyang Fei, Wen Guonan, Zhou Peng, and Fu Lin provide an ecological river bottom protecting ballast structure, to solve problems of poor deposition promotion and flow retardation effects of the river bottom protection structure in the prior art. The structure can provide a larger inhabitable space for benthos, and improve the ecological effect of the river bottom (China, CN 221398844 U).
9) Peng Hao, Li Biao, Zhang Yu, Ouyang Fei, Sun Baohu, Wen Guonan, Li Qiang, Li Peng, and Zhou Xiaochao provide a deposition-promoting and flow-retarding cellular concrete ecological bottom protection structure. By reducing a flow velocity near the river bottom protection structure from a plurality of directions, the bottom protection structure is kept stably (China, CN 219298114 U).
10) Peng Hao, Li Biao, Sun Baohu, Guo Min, Zhang Qin, Zhang Wen, Li Qiang, Cheng Zheng, Xu Xiuzhi, Wang Yaxuan, Geng Lei, and Li Peng provide a deposition-promoting and flow-retarding ecological concrete bottom plate structure. The structure facilitates silt deposition, enhancing deposition promotion, flow retardation and bottom protection for the river bottom protection structure. The structure makes use of thick and thin polyvinyl chloride (PVC) hollow tube bundles to simulate clustered plant communities, expanding a living space for fish and benthos (China, CN 218436887 U).

To sum up, with increasingly extensive material sources and ever-emerging novel structures, the ecological RBPE of the inland channel has become a main trend and a development direction of inland channel regulation at home and abroad. On the basis of the above background, it is desirable to research and establish a comprehensive evaluation index system and an evaluation method for an implementation effect of the ecological RBPE of the inland channel, so as to guide structural design, material selection and engineering construction of the ecological RBPE of the inland channel as well as comprehensive evaluation on the ecological effect in implementation, and serve for long-term monitoring on protection and restoration of the river ecosystem, thereby continuously improving the ecological construction level of the inland channel.

### SUMMARY

### (1) Objective

In view of the existing comprehensive evaluation method for the implementation effect of the ecological RBPE of the inland channel and its shortages and defects in long-term tracking and monitoring on the ecological restoration effect, the present disclosure provides a comprehensive evaluation method for an implementation effect of ecological RBPE of an inland channel. The present disclosure includes a comprehensive evaluation index system for the ecological RBPE of the inland channel, a weight and score criterion system of each index based on the comprehensive evaluation index system for the ecological RBPE of the inland channel, and an evaluation criterion system on the implementation effect of the ecological RBPE of the inland channel based on an ecological compliance index rating of river bottom protection engineering (ECIR-RBPE). The present disclosure provides a clear, complete, detailed, and quantifiable evaluation criterion system for evaluation on the implementation effect of the ecological RBPE of the inland channel, thereby providing a simple, easy-to-operate and economic evaluation method to guide structural design, material selection and engineering layout of the ecological RBPE of the inland channel as well as long-term tracking and monitoring on the restoration effect of the ecosystem.

### (2) Technical Solutions

Technical solutions adopted by the present disclosure to solve the technical problems are as follows: The present disclosure provides a comprehensive evaluation method for an implementation effect of ecological RBPE for an inland channel, including a comprehensive evaluation index system for the ecological RBPE of the inland channel, a weight and score criterion system of each index based on the comprehensive evaluation index system for the ecological RBPE of the inland channel, and an evaluation criterion system on the implementation effect of the ecological RBPE of the inland channel based on an ECIR-RBPE.

The comprehensive evaluation index system for the ecological RBPE of the inland channel includes two levels, specifically five categories and fourteen indexes included in the five categories, where the five categories in a first level include: a structural stability A1, a material eco-friendliness A2, an engineering layout rationality A3, an engineering economy A4, and an ecosystem service function A5; and the fourteen indexes in a second level respectively correspond to the structural stability A1, the material eco-friendliness A2, the engineering layout rationality A3, the engineering economy A4, and the ecosystem service function A5; and a specific corresponding relationship is as follows:
1) the structural stability A1 corresponds to a scour-resistant property A11 and a flow-retarding and deposition-promoting property A12;
2) the material eco-friendliness A2 corresponds to a proportion of a natural material A21 and a durability of an artificial organic synthetic material A22;
3) the engineering layout rationality A3 corresponds to a riverbed morphological stability A31 and an engineering disturbance ratio A32;
4) the engineering economy A4 corresponds to an engineering cost A41, an engineering construction complexity A42, and an engineering maintenance complexity A43; and
5) the ecosystem service function A5 corresponds to a vertical connectivity A51, a conduciveness for root penetration of an aquatic plant or growth of an attaching organism A52, a species number or a density of macrobenthos A53, a conduciveness for creation of diverse living environments and habitats A54, and an alien invasive species A55.

FIG. 1 shows a schematic view of the comprehensive evaluation index system for the ecological RBPE of the inland channel.

The weight and score criterion system of each index based on the comprehensive evaluation index system for the ecological RBPE of the inland channel includes a qualitative or quantitative evaluation criterion on weights and five grades for the five categories and the fourteen indexes in the two levels; different rating conditions of each of the fourteen indexes are divided into the five grades; the five grades are respectively assigned with decreasing points, sequentially including: 5 points (excellent), 4 points (good), 3 points (fair), 2 points (relatively poor), and 1 point (poor); and the evaluation criterion is specifically as follows:
1) for the scour-resistant property A11 (with a weight of 0.13): highly stable (no erosion, with a structural integrity rate of an ecological RBPE region being ≥85%); relatively stable (occasional erosion, with a structural integrity rate of an engineering region being 70-85%); moderately stable (moderate erosion, with a structural integrity rate of an engineering region being 50-70%); relatively unstable (more erosion, with a structural integrity rate of an engineering region being 30-50%); and unstable (extensive erosion, with a structural integrity rate of an engineering region being <30%);
2) for the flow-retarding and deposition-promoting property A12 (with a weight of 0.13): very good (significant sediment deposition in the ecological RBPE region, with an average deposition height being 0.3 m or above); relatively good (relatively obvious sediment deposition in the engineering region, with an average deposition height being 0.1-0.3 m); moderate (sediment deposition in the engineering region, with an average deposition height being 0-0.1 m); relatively poor (no obvious sediment deposition in the engineering region); and very poor (no deposition in the engineering region, and obvious scour);
3) for the proportion of a natural material A21 (with a weight of 0.08): 80-100% (a proportion of the natural material in unit area of the ecological RBPE by mass percent, and concrete and stone blocks being considered as the natural material), 60-80%, 40-60%, 20-40%, and <20%;
4) for the durability of an artificial organic synthetic material A22 (with a weight of 0.08): no artificial organic synthetic material; 50 years or above for durability of an artificial organic synthetic material; 20-50 years for a durability of an artificial organic synthetic material; 10-20 years for a durability of an artificial organic synthetic material; and 5-10 years for a durability of an artificial organic synthetic material;
5) for the riverbed morphological stability A31 (with a weight of 0.08): stable riverbed morphology, scour and deposition of the engineering region after the ecological RBPE is implemented; basically stable riverbed morphology, scour and deposition of the engineering region; small change for a riverbed morphology, scour and deposition of the engineering region; significant change for a riverbed morphology, scour and deposition of the engineering region; and great change for a riverbed morphology, scour and deposition of the engineering region;
6) for the engineering disturbance ratio A32 (with a weight of 0.08): <20% (a proportion of a disturbance area of the ecological RBPE region to a total riverbed area in a reach where the ecological RBPE region is located), 20-40%, 40-60%, 60-80%, and 80-100%;
7) for the engineering cost A41 (with a weight of 0.05): very good (a ratio of an ecological RBPE cost to a conventional RBPE cost is ≤1.0), relatively good (1.0-1.5), moderate (1.5-2), relatively poor (2-3), and very poor (3 and more);
8) for the engineering construction complexity A42 (with a weight of 0.05): very easy (a ratio of an ecological RBPE construction complexity to a conventional RBPE construction complexity is ≤1.0), relatively easy (1.0-1.5), moderate (1.5-2), relatively difficult (2-3), and very difficult (3 and above);
9) for the engineering maintenance complexity A43 (with a weight of 0.05): simple (basically no maintenance required), relatively simple (simple maintenance required), moderate (maintenance required every 3-5 years), relatively complex (maintenance required every 1-2 years), and complex (continuous maintenance required each year);
10) for the vertical connectivity A51 (with a weight of 0.06): the vertical connectivity is maintained in a natural state, such that exchange between overlying water and sediment is not affected by an ecological river bottom protection structure; the vertical connectivity is relatively good, such that exchange between overlying water and sediment is affected little; the vertical connectivity is moderate, such that exchange between overlying water and sediment is affected moderately; the vertical connectivity is relatively poor, such that exchange between overlying water and sediment is difficult; and the vertical connectivity is completely blocked, such that exchange between overlying water and sediment is completely isolated;
11) for the conduciveness for root penetration of an aquatic plant or growth of an attaching organism A52 (with a weight of 0.06): the ecological river bottom protection structure and an engineering layout are highly conducive to root penetration of an aquatic plant or growth of an attaching organism; a structure and an engineering layout are conducive to root penetration of an aquatic plant or growth of an attaching organism; a structure and an engineering layout are convenient to root penetration of an aquatic plant or growth of an attaching organism; a structure and an engineering layout are unconducive to root penetration of an aquatic plant or growth of an attaching organism; and a structure and an engineering layout are extremely unconducive to root penetration of an aquatic plant or growth of an attaching organism;
12) for the species number or the density of the macrobenthos A53 (with a weight of 0.06): a ratio of a species number or a density of macrobenthos in the ecological RBPE region to a species number or a density of macrobenthos in a region not protected by the RBPE is 80% or above; a ratio of a species number or a density of macrobenthos in the engineering region to a species number or a density of macrobenthos in a region not protected by the RBPE is 60-80%; a ratio of a species number or a density of macrobenthos in the engineering region to a species number or a density of macrobenthos in a region not protected by the RBPE is 40-60%, a ratio of a species number or a density of macrobenthos in the engineering region to a species number or a density of macrobenthos in a region not protected by the RBPE is 20-40%; and a ratio of a species number or a density of macrobenthos in the engineering region to a species number or a density of macrobenthos in a region not protected by the RBPE is <20%;
13) for the conduciveness for creation of diverse living environments and habitats A54 (with a weight of 0.05): the ecological river bottom protection structure and the engineering layout are highly conducive to create diverse living environments and habitats; the structure and the engineering layout are conducive to create diverse living environments and habitats; the structure and the engineering layout are convenient for settlement and habitation of an organism; the structure and the engineering layout are unconducive for settlement and habitation of an organism; and the structure and the engineering layout are extremely unconducive for settlement and habitation of an organism; and
14) for the alien invasive species A55 (with a weight of 0.04): no alien invasive species is observed; the alien invasive species is observed occasionally with a negligible hazard; the alien invasive species is observed commonly, without a hazard to an ecological environment; the alien invasive species is widespread to form a stable population and cause a hazard to an ecological environment; and the alien invasive species becomes dominant to cause a serious hazard to a native species and an ecological environment.

The evaluation criterion system on the implementation effect of the ecological RBPE of the inland channel based on the ECIR-RBPE includes the ECIR-RBPE, and an evaluation criterion system on a degree of compliance of the ecological RBPE of the inland channel, and specifically includes:
1) the ECIR-RBPE is calculated as follows: multiplying the weight of each of the fourteen indexes by a score of the index and adding all products to obtain a to-be-evaluated ECIR-RBPE; and
2) the evaluation criterion system on the degree of compliance of the ecological RBPE of the inland channel is as follows: according to a calculated ECIR-RBPE score, the implementation effect of the ecological RBPE of the inland channel is determined based on a following evaluation criterion: ECIR-RBPE≥4 points, excellent, indicating a high ecological compliance of an ecological river bottom protection structure; 3 points≤ECIR-RBPE≤4 points, good, indicating a good ecological compliance of an ecological river bottom protection structure; 2 points≤ECIR-RBPE<3 points, moderate, indicating a moderate ecological compliance of an ecological river bottom protection structure; 1 point ≤ECIR-RBPE<2 points, relatively poor, indicating a relatively poor ecological compliance of an ecological river bottom protection structure; and ECIR-RBPE<1 point, poor, indicating a poor ecological compliance of an ecological river bottom protection structure.

### (3) Advantages and Effects

The comprehensive evaluation method for an implementation effect of ecological RBPE of an inland channel provided by the present disclosure includes the comprehensive evaluation index system for the ecological RBPE of the inland channel, the weight and score criterion system of each index based on the comprehensive evaluation index system for the ecological RBPE of the inland channel, and the evaluation criterion system on the implementation effect of the ecological RBPE of the inland channel based on an ECIR-RBPE. The advantages and the effects are manifested as follows:
1) The constructed comprehensive evaluation index system for the ecological RBPE of the inland channel includes two levels, specifically five categories including the structural stability, the material eco-friendliness, the engineering layout rationality, the engineering economy, and the ecosystem service function as well as fourteen classified indexes included in the five categories, providing the clear and complete evaluation index system for evaluation on the implementation effect of the ecological RBPE of the inland channel.
2) The constructed weight and score criterion system of each classified index based on the comprehensive evaluation index system for the ecological RBPE of the inland channel includes the qualitative or quantitative evaluation criterion on the weights and five ratings for the five categories and the fourteen indexes in the two levels, providing the detailed and quantifiable evaluation criterion system for evaluation on the implementation effect of the ecological RBPE of the inland channel.
3) The constructed evaluation criterion system on the implementation effect of the ecological RBPE of the inland channel based on the ECIR-RBPE includes the ECIR-RBPE, and the evaluation criterion system on the implementation effect of the ecological RBPE of the inland channel for five grades of the ECIR-RBPE, providing a simple, easy-to-operate and economic evaluation method for quantitative evaluation on the ecological restoration effect of the ecological RBPE, guidance on structural design, material selection and engineering layout of the ecological RBPE of the inland channel as well as long-term tracking and monitoring on the restoration effect of the ecosystem.

The present disclosure makes up technical defects in long-term tracking and monitoring on the ecological restoration effect of the ecological RBPE of the inland channel, fills a blank of the comprehensive evaluation method for the implementation effect of the ecological RBPE of the inland channel, and provides a technical support for construction evaluation on the inland ecological channel.

### BRIEF DESCRIPTION OF THE DRAWINGS

FIG. 1 illustrates a comprehensive evaluation index system on an implementation effect of ecological RBPE of an inland channel;

FIG. 2 illustrates a structural layout diagram of a stereoscopic-component ecological mattress;

FIG. 3 illustrates a structural diagram of an active hooked structure; and

FIGS. 4A-4D illustrate structural diagram of a novel permeable frame.

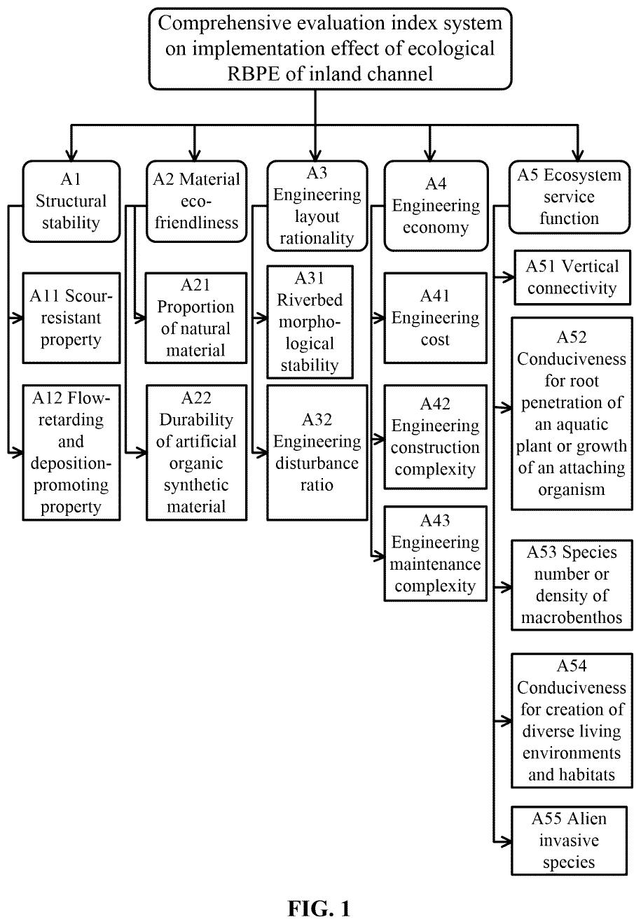

### DETAILED DESCRIPTION OF THE EMBODIMENTS

The implementations of the present disclosure are further described below with reference to accompanying drawings and cases.

The “phase II project of the 12.5 m deep channel in the Yangtze River below Nanjing” (hereinafter referred to as “Phase II Project”) focuses on the Fujiangsha waterway, Kouanzhi waterway, Changzhou waterway, and Yizheng waterway, covering 227 km of the reach. The project was commenced in June 2015, and was completed and handed over for acceptance in June 2017. The present disclosure takes three ecological river bottom protection structures in the “Phase II Project”, including a stereoscopic-component ecological mattress, an active hooked structure and a novel permeable frame, as specific implementation cases. By looking up the relevant engineering design documents, consulting the engineering construction headquarter, and making field investigation, comprehensive analysis is conducted. With reference to the comprehensive evaluation index system and score criterion system for the ecological RBPE of the inland channel, each index in the three typical ecological river bottom protection structures and in the conventional riprap river bottom protection structure is scored. ECIR-RBPEs of the four river bottom protection structures are calculated, and an implementation effect of the engineering is evaluated. Table 1 shows a weight and score criterion system of each index in the comprehensive evaluation index system for the ecological RBPE of the inland channel.

TABLE 1
Weight and score standard of the comprehensive evaluation index on the
implementation effect of the ecological RBPE of the inland channel

| | | Score criterion and grade | | | | |
|---|---|---|---|---|---|---|
| | | | | | 2 points | |
| | | 5 points | 4 points | 3 points | (relatively | 1 point |
| Category | Index and weight | (excellent) | (good) | (fair) | poor) | (poor) |
| A1 Structural | A11 Scour-resistant | Highly stable | Relatively | Moderately | Relatively | Unstable |
| stability | property (0.13) | (No erosion, | stable | stable | unstable | (Extensive |
| | | with a | (Occasional | (Moderate | (More scour, | erosion, with |
| | | structural | erosion, with a | erosion, with | with a | a structural |
| | | integrity rate | structural | a structural | structural | integrity rate |
| | | of an | integrity rate | integrity rate | integrity rate | of an |
| | | ecological | of an | of an | of an | engineering |
| | | RBPE region | engineering | engineering | engineering | region |
| | | being ≥85%) | region being | region being | region being | being <30%) |
| | | | 70-85%) | 50-70%) | 30-50%) | |
| | A12 Flow-retarding | Very | Relatively | Moderate | Relatively | Very poor |
| | and | good | good | (Sediment | poor | (No |
| | deposition-promoting | (Significant | (Relatively | deposition in | (No obvious | deposition in |
| | property (0.13) | sediment | obvious | the | sediment | the |
| | | deposition in | sediment | engineering | deposition in | engineering |
| | | the | deposition in | region, with | the | region, and |
| | | ecological | the | an average | engineering | obvious |
| | | RBPE | engineering | deposition | region) | scour) |
| | | region, with | region, with | height being | | |
| | | an average | an average | 0-0.1 m) | | |
| | | deposition | deposition | | | |
| | | height being | height being | | | |
| | | 0.3 m or | 0.1-0.3 m) | | | |
| | | above) | | | | |
| A2 Material | A21 Proportion of | 80-100% | 60%-80% | 40%-60% | 20%-40% | <20% |
| eco-friendliness | natural material | (A proportion | | | | |
| | (0.08) | of the natural | | | | |
| | | material in | | | | |
| | | unit area of | | | | |
| | | the | | | | |
| | | ecological | | | | |
| | | RBPE by | | | | |
| | | mass percent, | | | | |
| | | and concrete | | | | |
| | | and stone | | | | |
| | | blocks being | | | | |
| | | considered as | | | | |
| | | the natural | | | | |
| | | material) | | | | |
| | A22 Durability of | No artificial | 50 years or | 20-50 years | 10-20 years | 5-10 years |
| | artificial organic | organic | above for | for a | for a | for a |
| | synthetic material | synthetic | durability of | durability of | durability of | durability of |
| | (0.08) | material | an artificial | an artificial | an artificial | an artificial |
| | | | organic | organic | organic | organic |
| | | | synthetic | synthetic | synthetic | synthetic |
| | | | material | material | material | material |
| A3 | A31 Riverbed | Stable | Basically | Small change | Significant | Great change |
| Engineering | morphological | riverbed | stable riverbed | for a riverbed | change for a | for a riverbed |
| layout | stability (0.08) | morphology, | morphology, | morphology, | riverbed | morphology, |
| rationality | | scour and | scour and | scour and | morphology, | scour and |
| | | deposition of | deposition of | deposition of | scour and | deposition of |
| | | the | the | the | deposition of | the |
| | | engineering | engineering | engineering | the | engineering |
| | | region after | region | region | engineering | region |
| | | the | | | region | |
| | | ecological | | | | |
| | | RBPE is | | | | |
| | | implemented | | | | |
| | A32 Engineering | <20% | 20%-40% | 40%-60% | 60%-80% | 80-100% |
| | disturbance ratio | (A proportion | | | | |
| | (0.08) | of a | | | | |
| | | disturbance | | | | |
| | | area of the | | | | |
| | | ecological | | | | |
| | | RBPE region | | | | |
| | | to a total | | | | |
| | | riverbed area | | | | |
| | | at a reach | | | | |
| | | where the | | | | |
| | | ecological | | | | |
| | | RBPE region | | | | |
| | | is located) | | | | |
| A4 | A41 Engineering | Very | Relatively | Moderate | Relatively | Very |
| Engineering | cost (0.05) | good | good | (1.5-2) | poor | poor |
| economy | | (A ratio of an | (1.0-1.5) | | (2-3) | (3 and above |
| | | ecological | | | | |
| | | RBPE cost to a | | | | |
| | | conventional | | | | |
| | | RBPE cost | | | | |
| | | is ≤1.0) | | | | |
| | A42 Engineering | Very easy | Relatively | Moderate | Relatively | Very |
| | construction | (A ratio of an | easy | (1.5-2) | difficult | difficult |
| | complexity (0.05) | ecological | (1.0-1.5) | | (2-3) | (3 and above) |
| | | RBPE | | | | |
| | | construction | | | | |
| | | complexity | | | | |
| | | to a | | | | |
| | | conventional | | | | |
| | | RBPE | | | | |
| | | construction | | | | |
| | | complexity | | | | |
| | | is ≤1.0) | | | | |
| | A43 Engineering | Simple | Relatively | Moderate | Relatively | Complex |
| | maintenance | (Basically no | simple | (Maintenance | poor | (Continuous |
| | complexity (0.05) | maintenance | (Simple | required | (Maintenance | maintenance |
| | | required) | maintenance | every 3-5 | required | required each |
| | | | required) | years) | every 1-2 | year) |
| | | | | | years) | |
| A5 Ecosystem | A51 Vertical | The vertical | The vertical | The vertical | The vertical | The vertical |
| service | connectivity (0.06) | connectivity | connectivity is | connectivity | connectivity | connectivity |
| function | | is maintained | relatively | is moderate, | is relatively | is completely |
| | | in a natural | good, such | such that | poor, such | blocked, such |
| | | state, such | that exchange | exchange | that exchange | that exchange |
| | | that | between | between | between | between |
| | | exchange | overlying | overlying | overlying | overlying |
| | | between | water and | water and | water and | water and |
| | | overlying | sediment is | sediment is | sediment is | sediment is |
| | | water and | affected little | affected | difficult | completely |
| | | sediment is | | moderately | | isolated |
| | | not affected | | | | |
| | | by a structure | | | | |
| | | of the | | | | |
| | | ecological | | | | |
| | | river bottom | | | | |
| | | protection | | | | |
| | A52 Conduciveness | The | A structure | A structure | A structure | A structure |
| | for root penetration | ecological | and an | and an | and an | and an |
| | of an aquatic plant | river bottom | engineering | engineering | engineering | engineering |
| | or growth of an | protection | layout are | layout are | layout are | layout are |
| | attaching organism | structure and | conducive to | convenient to | unconducive | extremely |
| | (0.06) | an | root | root | to root | unconducive |
| | | engineering | penetration of | penetration | penetration of | to root |
| | | layout are | an aquatic | of an aquatic | an aquatic | penetration |
| | | highly | plant or | plant or | plant | of an aquatic |
| | | conducive to | growth of an | growth of an | or | plant or |
| | | root | attaching | attaching | growth of an | growth of an |
| | | penetration | organism | organism | attaching | attaching |
| | | of an aquatic | | | organism | organism |
| | | plant or | | | | |
| | | growth of an | | | | |
| | | attaching | | | | |
| | | organism | | | | |
| | A53 Species number | A ratio of a | A ratio of a | A ratio of a | A ratio of a | A ratio of a |
| | or density of | species | species | species | species | species |
| | macrobenthos (0.06) | number or a | number or a | number or a | number or a | number or a |
| | | density of | density of | density of | density of | density of |
| | | macrobenthos | macrobenthos | macrobenthos | macrobenthos | macrobenthos |
| | | in the | in the | in the | in the | in the |
| | | ecological | engineering | engineering | engineering | engineering |
| | | RBPE region | region to a | region to a | region to a | region to |
| | | to a species | species | species | species | species |
| | | number or a | number or a | number or a | number or a | number or a |
| | | density of | density of | density of | density of | density of |
| | | macrobenthos | macrobenthos | macrobenthos | macrobenthos | macrobenthos |
| | | in a region | in a region not | in a region | in a region | in a region |
| | | not protected | protected by | not protected | not protected | not protected |
| | | by the RBPE | the RBPE is | by the RBPE | by the RBPE | by the RBPE |
| | | is 80% or | 60-80% | is 40-60% | is 20-40% | is <20% |
| | | above | | | | |
| | A54 Conduciveness | The | The structure | The structure | The structure | The structure |
| | for | ecological | and the | and the | and the | and the |
| | creation of | river bottom | engineering | engineering | engineering | engineering |
| | diverse living | protection | layout are | layout are | layout are | layout are |
| | environments and | structure | conducive to | convenient | unconducive | extremely |
| | habitats (0.05) | and the | create diverse | for | for settlement | unconducive |
| | | engineering | living | settlement | and habitation | for settlement |
| | | layout are | environments | and | of an | and |
| | | highly | and habitats | habitation of | organism | habitation of |
| | | conducive to | | an organism | | an organism |
| | | create | | | | |
| | | diverse living | | | | |
| | | environments | | | | |
| | | and habitats | | | | |
| | A55 Alien invasive | No alien | The alien | The alien | The alien | The alien |
| | species (0.04) | invasive | invasive | invasive | invasive | invasive |
| | | species is | species is | species is | species is | species |
| | | observed | observed | observed | widespread to | becomes |
| | | | occasionally | commonly, | form a stable | dominant to |
| | | | with a | without a | population | cause a |
| | | | negligible | hazard to an | and cause a | serious |
| | | | hazard | ecological | hazard to an | hazard to a |
| | | | | environment | ecological | native |
| | | | | | environment | species and |
| | | | | | | an ecological |
| | | | | | | environment |

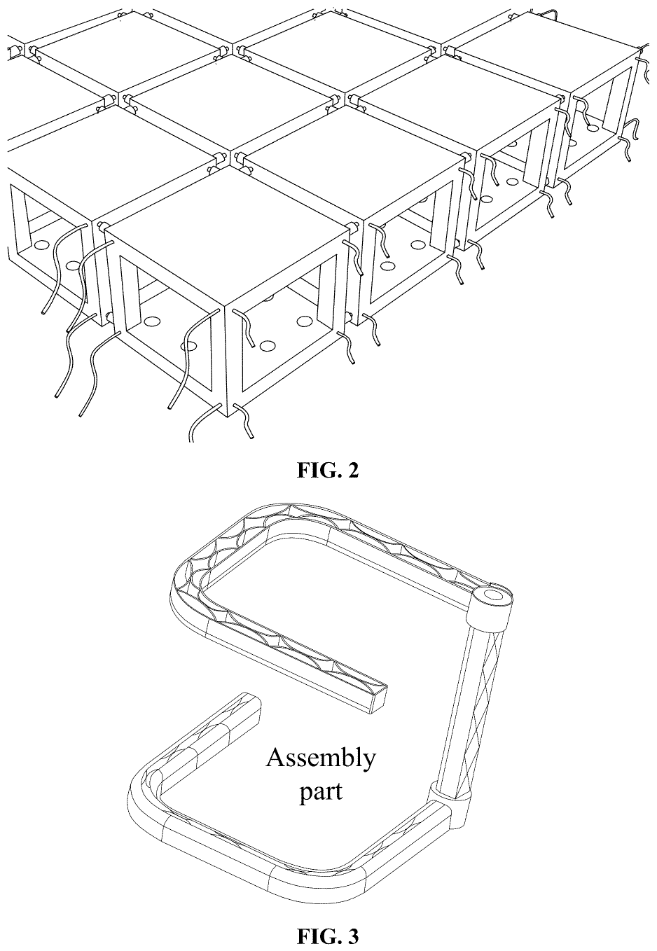

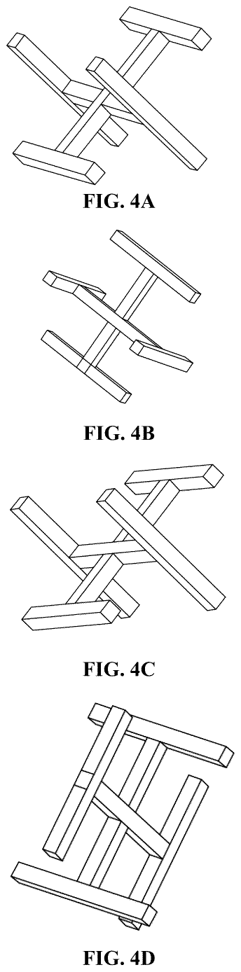

In this case, the stereoscopic-component ecological mattress (FIG. 2) includes a conventional mattress and a novel ecological stereoscopic component that is a ballast block. The stereoscopic-component ecological mattress uses the common arrangement, and is composited by a 150 g/m² non-woven fabric and a 350 g/m² filament woven fabric. In order to enhance the arrangement strength, two 7 cm polypropylene reinforced tapes are provided. The novel ecological stereoscopic component is provided to form a stereoscopic space with a large permeability, thereby retarding a flow velocity of bottom water and providing a suitable living environment for organisms. The ballast block has overall dimensions of 60 cm×60 cm×40 cm (length×width×height), includes a top plate, a bottom plate, and four posts, and is made of C30 concrete. The active hooked structure is a seven-sided stereoscopic structure with a side length of 60 cm, a cross-section of 6 cmx 6 cm, and a wall thickness of 2-3 cm. It takes polypropylene as a base material and barium sulfate as a weight increasing material, and is added with a plurality of additives according to a certain proportion. The active hooked structure has a flow-retarding and deposition-promoting effect, without obstructing the exchange between the water and the sediment (FIG. 3). With a double-I-shape, the novel permeable frame is made of an RC material. The internal rebar has a diameter of 8 mm, the concrete strength is C30, and the frame structure has dimensions of 800 mm×100 mm×100 mm. The structure functions to retard the flow and promote the deposition, with no obstruction to water-soil exchange, and permeability to water and sand. It is the eco-friendly structure, and can function as an artificial fish reef. In the frame, habitats can be provided for aquatic organisms such as fish (FIGS. 4A-4D).

Specific points for various indexes in comprehensive evaluation on implementation effects of the three ecological river bottom protection structures including the stereoscopic-component ecological mattress, the active hooked structure and the novel permeable frame and on the implementation effect of the conventional riprap river bottom protection structure are as follows:
1) For the scour-resistant property A11: According to investigation, the three ecological river bottom protection structures, namely the stereoscopic-component ecological mattress, the active hooked structure and the novel permeable frame, are relatively stable at a test section, only with occasional slight erosion, and the index is evaluated as 4 points. With deposition of sediment between stone blocks, the conventional riprap river bottom protection structure is very stable, and the index is evaluated as 5 points.
2) For the flow-retarding and deposition-promoting property A12: According to investigation, the engineering region with the stereoscopic-component ecological mattress has a relatively uniform particle size of the sediment, with a deposition height of less than 0.10 m. The index is evaluated as 3 points. The engineering region with the active hooked structure has a significant deposition promoting effect, with an average deposition height of 0.48 m, and the index is evaluated as 5 points. The engineering region with the novel permeable frame has a relatively obvious deposition promoting effect, with an average deposition height of 0.27 m, and the index is evaluated as 4 points. In the engineering region with the conventional riprap river bottom protection structure, a gap between the stone blocks is not filled by the sediment, and no obvious sediment deposition appears. The index is evaluated as 2 points.
3) For the proportion of a natural material A21: By looking up the relevant design documents of the ecological RBPE, the stereoscopic component of the stereoscopic-component ecological mattress is made of the concrete. With the common arrangement, the mattress is made of an artificial synthetic material. The natural material accounts for about 85% by mass percent, and thus the index is evaluated as 5 points. The active hooked structure takes the polypropylene as the base material and the barium sulfate as the weight increasing material, and is added with a plurality of additives according to a certain proportion. The natural material accounts for about 75% by mass percent, and thus the index is evaluated as 4 points. The novel permeable frame is made of the RC material, and thus the index is evaluated as 5 points. The riprap river bottom protection structure is made of the stone block. The natural material accounts for about 100% by mass percent, and thus the index is evaluated as 5 points.
4) For the durability of an artificial organic synthetic material A22: By looking up the relevant design documents of the ecological RBPE, the durability of the artificial organic synthetic material of the stereoscopic-component ecological mattress in clean water is 50 years or above, and thus the index is evaluated as 4 points. The durability of the polypropylene of the active hooked structure is also 50 years or above, and thus the index is evaluated as 4 points. The novel permeable frame does not contain the artificial organic synthetic material, and thus the index is evaluated as 5 points. The riprap river bottom protection structure is made of the natural material completely, and thus the index is evaluated as 5 points.
5) For the riverbed morphological stability A31: By looking up the relevant design documents of the ecological RBPE and making the field investigation, after the engineering is implemented, at the reach of the Yangtze River where these river bottom protection structures are located, the riverbed morphology, the scour and the deposition keep stable, no significant scour appears, and thus the index is evaluated as 5 points.
6) For the engineering disturbance ratio A32: By looking up the relevant design documents of the ecological RBPE, the disturbance area of each of the engineering regions where the four river bottom protection structures are located accounts for 20% of the riverbed area of the reach, and thus the index is evaluated as 5 points.
7) For the engineering cost A41: By looking up the relevant engineering design documents and consulting the engineering construction headquarter, compared with the conventional river bottom protection structure, the stereoscopic-component ecological mattress is 1.5-2 times the conventional concrete block soft mattress in engineering cost, and thus the index is evaluated as 3 points. The active hooked structure and the novel permeable frame are 1.0-1.5 times the conventional modular frame or component in engineering cost, and thus the index is evaluated as 4 points. For the riprap RBPE, the index is evaluated as 5 points.
8) For the engineering construction complexity A42: By looking up the relevant engineering design documents and consulting the engineering construction headquarter, the stereoscopic component of the stereoscopic-component ecological mattress is to be prefabricated, assembled, reinforced, etc. The pavement process is basically the same as that of the conventional concrete block soft mattress, the complexity is 1.5-2 times the conventional engineering, and thus the index is evaluated as 3 points. The active hooked structure may be assembled by a single accessory and then thrown randomly. The hooked structure may also be bound with the grid, the grid is laid down by a mattress laying ship, and the ship is moved for construction. The complexity is 1.5-2 times the conventional engineering, and thus the index is evaluated as 3 points. The novel permeable frame is manufactured with a mold, placed on a loading platform of a special ship, and thrown by the construction chip. The complexity is 1.0-1.5 times the conventional engineering, and thus the index is evaluated as 4 points. For the riprap RBPE, the index is evaluated as 5 points.
9) For the engineering maintenance complexity A43: By consulting the engineering construction headquarter and making the field investigation, the stereoscopic-component ecological mattress, the active hooked structure and the novel permeable frame are basically intact after 1 year, and are only maintained simply. The index is evaluated as 4 points. For the conventional riprap RBPE, basically no maintenance required is required during the operation period, and thus the index is evaluated as 5 points.
10) For the vertical connectivity A51: According to the investigation, the stereoscopic-component ecological mattress uses the common arrangement, and is composted by the 150 g/m² non-woven fabric and the 350 g/m² filament woven fabric, basically obstructing the exchange between the overlying water and the sediment. Thus, the vertical connectivity is poor, and the index is evaluated as 2 points. Both the active hooked structure and the novel permeable frame do not obstruct the exchange between the overlying water and the sediment, such that the vertical connectivity is relatively good and the index is evaluated as 4 points. For the conventional riprap river bottom protection structure, the exchange between the overlying water and the sediment can be realized through the gap between the stone blocks, such that the vertical connectivity is moderate, and the index is evaluated as 3 points.
11) For the conduciveness for root penetration of an aquatic plant or growth of an attaching organism A52: According to the investigation, although the stereoscopic component of the stereoscopic-component ecological mattress is highly conducive to attachment and growth of the aquatic organisms, the arrangement is unconducive to root growth of the aquatic plants. Thus, the index is evaluated as 4 points. The active hooked structure and the novel permeable frame have the ecological function of the artificial fish reef, and their structure and layout are convenient to reduce the flow velocity of the water and highly conducive to root penetration of an aquatic plant or growth of an attaching organism. Thus, the index is evaluated as 5 points. The conventional riprap river bottom protection structure is convenient for the attachment and growth of the aquatic organisms, and thus the index is evaluated as 3 points.
12) For the species number or the density of the macrobenthos A53: According to the investigation, four types of macrobenthos are detected in the unprotected region. Fix types of macrobenthos are detected in the engineering region with the stereoscopic-component ecological mattress, accounting for 150%. Thus, the index is evaluated as 5 points. Four types of macrobenthos are detected in the engineering region with the active hooked structure, accounting for 100%. Thus, the index is evaluated as 5 points. Four types of macrobenthos are detected in the engineering region with the novel permeable frame, accounting for 100%. Thus, the index is evaluated as 5 points. For the region with the conventional riprap river bottom protection structure, no macrobenthos are detected, accounting for 20%. Thus, the index is evaluated as 1 point.
13) For the conduciveness for creation of diverse living environments and habitats A54: According to the investigation, the novel ecological stereoscopic component of the stereoscopic-component ecological mattress can form the stereoscopic space with the high permeability, which is highly conducive to create diverse living environments and habitats. Thus, the index is evaluated as 5 points. The active hooked structure and the novel permeable frame have a high permeability and function as the artificial fish reef. In the frame, a shelter can be provided for the aquatic organisms such as the fish. The active hooked structure and the novel permeable frame are conducive to create diverse living environments and habitats, and thus the index is evaluated as 4 points. The region with the conventional riprap river bottom protection structure is unconducive for settlement and inhabitation of an organism, and is unconducive to create diverse living environments and habitats. Thus, the index is evaluated as 2 points.
14) For the alien invasive species A56: According to the field investigation, and with reference to the List of Key Invasive Alien Species for Priority Management, no alien invasive species is found in the regions with the four river bottom protection structures, and thus the index is evaluated as 5 points.

Table 2 shows a score result of each index in comprehensive evaluation on the implementation effect of the ecological RBPE in the Phase-II Project.

TABLE 2
Comprehensive evaluation results on the implementation effect of the ecological
RBPE of the 12.5 m deep channel in the Yangtze River below Nanjing

| | | Score | | | |
|---|---|---|---|---|---|
| | | | | | Traditional |
| | | Stereoscopic- | | | riprap river |
| | | component | Active | Novel | bottom |
| | | ecological | hooked | permeable | protection |
| Category | Index | mattress | structure | frame | structure |
| A1 Structural | A11 Scour-resistant property | 4 | 4 | 4 | 5 |
| stability | A12 Flow-retarding and | 3 | 5 | 4 | 2 |
| | deposition-promoting property | | | | |
| A2 Material | A21 Proportion of natural material | 5 | 4 | 5 | 5 |
| eco-friendliness | A22 Durability of artificial organic | 4 | 4 | 5 | 5 |
| | synthetic material | | | | |
| A3 Engineering | A31 Riverbed morphological stability | 5 | 5 | 5 | 5 |
| layout rationality | A32 Engineering disturbance ratio | 5 | 5 | 5 | 5 |
| A4 Engineering | A41 Engineering cost | 3 | 4 | 4 | 5 |
| economy | A42 Engineering construction | 3 | 3 | 4 | 5 |
| | complexity | | | | |
| | A43 Engineering maintenance | 4 | 4 | 4 | 5 |
| | complexity | | | | |
| A5 Ecosystem | A51 Vertical connectivity | 2 | 4 | 4 | 3 |
| service function | A52 Conduciveness for root penetration | 4 | 5 | 5 | 3 |
| | of an aquatic plant or growth of an | | | | |
| | attaching organism | | | | |
| | A53 Species number or density of | 5 | 5 | 5 | 1 |
| | macrobenthos | | | | |
| | A54 Conduciveness for creation of | 5 | 4 | 4 | 2 |
| | diverse living environments and habitats | | | | |
| | A55 Alien invasive species | 5 | 5 | 5 | 5 |

| | | | | |
|---|---|---|---|---|
| ECIR-RBPE | 4.04 | 4.40 | 4.48 | 3.98 |

According to a calculation method and an evaluation criterion of the ECIR-RBPE, the ECIR-RBPEs of the stereoscopic-component ecological mattress, the active hooked structure and the novel permeable frame in the Phase-II Project, as well as the ECIR-RBPE of the conventional riprap river bottom protection structure, are calculated (refer to Table. 2), and graded. Results reveal that the ECIR-RBPE of the stereoscopic-component ecological mattress is 4.04, and graded as excellent, the ECIR-RBPE of the active hooked structure is 4.40, and graded as excellent, the ECIR-RBPE of the novel permeable frame is 4.48, and graded as excellent, and the ECIR-RBPE of the conventional riprap river bottom protection structure is 3.98, and graded as good.

Therefore, according to the comprehensive evaluation result on the implementation effect of the ecological RBPE in the Phase-II Project, the novel permeable frame and the active hooked structure achieve the best ecological restoration effect, followed by the stereoscopic-component ecological mattress, and lastly by the conventional riprap river bottom protection structure.

What is claimed is:

1. A comprehensive evaluation method for an implementation effect of ecological river bottom protection engineering (RBPE) of an inland channel, comprising: a comprehensive evaluation index system for the ecological RBPE of the inland channel, a weight and score criterion system of each index based on the comprehensive evaluation index system for the ecological RBPE of the inland channel, and an evaluation criterion system on the implementation effect of the ecological RBPE of the inland channel based on an ecological compliance index rating of river bottom protection engineering (ECIR-RBPE), wherein
the comprehensive evaluation index system for the ecological RBPE of the inland channel comprises two levels, wherein five categories and fourteen indexes comprised in the five categories, wherein the five categories in a first level comprise: a structural stability A1, a material eco-friendliness A2, an engineering layout rationality A3, an engineering economy A4, and an ecosystem service function A5; and the fourteen indexes in a second level respectively correspond to the structural stability A1, the material eco-friendliness A2, the engineering layout rationality A3, the engineering economy A4, and the ecosystem service function A5;
a corresponding relationship is as follows:
(1) the structural stability A1 corresponds to a scour-resistant property A11 and a flow-retarding and deposition-promoting property A12;
(2) the material eco-friendliness A2 corresponds to a proportion of a natural material A21 and a durability of an artificial organic synthetic material A22;
(3) the engineering layout rationality A3 corresponds to a riverbed morphological stability A31 and an engineering disturbance ratio A32;
(4) the engineering economy A4 corresponds to an engineering cost A41, an engineering construction complexity A42, and an engineering maintenance complexity A43; and
(5) the ecosystem service function A5 corresponds to a vertical connectivity A51, a conduciveness for root penetration of an aquatic plant or growth of an attaching organism A52, a species number or a density of macrobenthos A53, a conduciveness for creation of diverse living environments and habitats A54, and an alien invasive species A55;
the weight and score criterion system of each index based on the comprehensive evaluation index system for the ecological RBPE of the inland channel comprises a qualitative or quantitative evaluation criterion on weights and five ratings for the fourteen indexes; different rating conditions of each of the fourteen indexes are divided into five grades; and the five grades are respectively assigned with decreasing points, sequentially comprising: 5 points, excellent; 4 points, good; 3 points, fair; 2 points, relatively poor; and 1 point, poor;
the evaluation criterion is as follows:
1) for the scour-resistant property A11, with a weight of 0.13: highly stable, no erosion, with a structural integrity rate of an ecological RBPE region being ≥85%; relatively stable, occasional erosion, with a structural integrity rate of an engineering region being 70-85%; moderately stable, moderate erosion, with a structural integrity rate of an engineering region being 50-70%; relatively unstable, more erosion, with a structural integrity rate of an engineering region being 30-50%; and unstable, extensive erosion, with a structural integrity rate of an engineering region being <30%;
2) for the flow-retarding and deposition-promoting property A12, with a weight of 0.13: very good, significant sediment deposition in the ecological RBPE region, with an average deposition height being 0.3 m or above; relatively good, relatively obvious sediment deposition in the engineering region, with an average deposition height being 0.1-0.3 m; moderate, sediment deposition in the engineering region, with an average deposition height being 0-0.1 m; relatively poor, no obvious sediment deposition in the engineering region; and very poor, no deposition in the engineering region, and obvious scour;
3) for the proportion of the natural material A21, a proportion of the natural material in unit area of the ecological RBPE by mass percent, concrete and stone blocks being considered as the natural material, and a weight being 0.08:80-100%, 60-80%, 40-60%, 20-40%, and <20%;
4) for the durability of the artificial organic synthetic material A22, with a weight of 0.08: no artificial organic synthetic material; 50 years or above for a durability of an artificial organic synthetic material; 20-50 years for a durability of an artificial organic synthetic material; 10-20 years for a durability of an artificial organic synthetic material; and 5-10 years for a durability of an artificial organic synthetic material;
5) for the riverbed morphological stability A31, with a weight of 0.08: stable riverbed morphology, scour and deposition of the engineering region after the ecological RBPE is implemented; basically stable riverbed morphology, scour and deposition of the engineering region; small change for a riverbed morphology, scour and deposition of the engineering region; significant change for a riverbed morphology, scour and deposition of the engineering region; and great change for a riverbed morphology, scour and deposition of the engineering region;
6) for the engineering disturbance ratio A32, a proportion of a disturbance area of the ecological RBPE region to a total riverbed area in a reach where the ecological RBPE region is located, with a weight of 0.08: <20%, 20-40%, 40-60%, 60-80%, and 80-100%;
7) for the engineering cost A41, a ratio of an ecological RBPE cost to a conventional RBPE cost, with a weight of 0.05: very good, ≤1.0; relatively good, 1.0-1.5; moderate 1.5-2; relatively poor, 2-3; and very poor, 3 and above;
8) for the engineering construction complexity A42, a ratio of an ecological RBPE construction complexity to a conventional RBPE construction complexity, with a weight of 0.05: very easy, ≤1.0; relatively easy, 1.0-1.5; moderate, 1.5-2; relatively difficult, 2-3; and very difficult, 3 and above;
9) for the engineering maintenance complexity A43, with a weight of 0.05: simple, basically no maintenance required; relatively simple, simple maintenance required; moderate, maintenance required every 3-5 years; relatively complex, maintenance required every 1-2 years; and complex, continuous maintenance required each year;
10) for the vertical connectivity A51, with a weight of 0.06: the vertical connectivity is maintained in a natural state, wherein exchange between overlying water and sediment is not affected by an ecological river bottom protection structure; the vertical connectivity is relatively good, wherein exchange between overlying water and sediment is affected little; the vertical connectivity is moderate, wherein exchange between overlying water and sediment is affected moderately; the vertical connectivity is relatively poor, wherein exchange between overlying water and sediment is difficult; and the vertical connectivity is completely blocked, wherein exchange between overlying water and sediment is completely isolated;
11) for the conduciveness for root penetration of an aquatic plant or growth of an attaching organism A52, with a weight of 0.06: the ecological river bottom protection structure and an engineering layout are highly conducive to root penetration of an aquatic plant or growth of an attaching organism; a structure and an engineering layout are conducive to root penetration of an aquatic plant or growth of an attaching organism; a structure and an engineering layout are convenient to root penetration of an aquatic plant or growth of an attaching organism; a structure and an engineering layout are unconducive to root penetration of an aquatic plant or growth of an attaching organism; and a structure and an engineering layout are extremely unconducive to root penetration of an aquatic plant or growth of an attaching organism;
12) for the species number or the density of macrobenthos A53, with a weight of 0.06: a ratio of a species number or a density of macrobenthos in the ecological RBPE region to a species number or a density of macrobenthos in a region not protected by the RBPE is 80% or above; a ratio of a species number or a density of macrobenthos in the engineering region to a species number or a density of macrobenthos in a region not protected by the RBPE is 60-80%; a ratio of a species number or a density of macrobenthos in the engineering region to a species number or a density of macrobenthos in a region not protected by the RBPE is 40-60%; a ratio of a species number or a density of macrobenthos in the engineering region to a species number or a density of macrobenthos in a region not protected by the RBPE is 20-40%; and a ratio of a species number or a density of macrobenthos in the engineering region to a species number or a density of macrobenthos in a region not protected by the RBPE is <20%;
13) for the conduciveness for creation of diverse living environments and habitats A54, with a weight of 0.05: the ecological river bottom protection structure and the engineering layout are highly conducive to create diverse living environments and habitats; the structure and the engineering layout are conducive to create diverse living environments and habitats; the structure and the engineering layout are convenient for settlement and habitation of an organism; the structure and the engineering layout are unconducive for settlement and habitation of an organism; and the structure and the engineering layout are extremely unconducive for settlement and habitation of an organism; and
14) for the alien invasive species A55, with a weight of 0.04: no alien invasive species is observed; the alien invasive species is observed occasionally with a negligible hazard; the alien invasive species is observed commonly, without a hazard to an ecological environment; the alien invasive species is widespread to form a stable population and cause a hazard to an ecological environment; and the alien invasive species becomes dominant to cause a serious hazard to a native species and an ecological environment; and
the evaluation criterion system on the implementation effect of the ecological RBPE of the inland channel based on the ECIR-RBPE comprises the ECIR-RBPE, and an evaluation criterion system on a degree of compliance of the ecological RBPE of the inland channel, and comprises:
a, the ECIR-RBPE is calculated by multiplying the weight of each of the fourteen indexes with a score of the index and adding all products; and
b, the evaluation criterion system on the degree of compliance of the ecological RBPE of the inland channel is as follows: according to a calculated ECIR-RBPE score, the implementation effect of the ecological RBPE of the inland channel is determined based on a following evaluation criterion: ECIR-RBPE≥4 points, excellent, indicating a high ecological compliance of an ecological river bottom protection structure; 3 points≤ECIR-RBPE<4 points, good, indicating a good ecological compliance of an ecological river bottom protection structure; 2 points≤ECIR-RBPE<3 points, moderate, indicating a moderate ecological compliance of an ecological river bottom protection structure; 1 point ≤ECIR-RBPE<2 points, relatively poor, indicating a relatively poor ecological compliance of an ecological river bottom protection structure; and ECIR-RBPE<1 point, poor, indicating a poor ecological compliance of an ecological river bottom protection structure.
